(19) United States
(12) Patent Application Publication
(10) Pub. No.: US 2012/0284315 A1
(43) Pub. Date: Nov. 8, 2012

(54) OPTIMIZATION OF NON-DETERMINISTIC COMPUTATIONAL PATHS

(75) Inventors: ZHENGHAO WANG, Redmond, WA (US); SHENGQUAN YAN, Issaquah, WA (US); AN YAN, Sammamish, WA (US); JEFFREY ERIC LARSSON, Kirkland, WA (US); ZIJIAN ZHENG, Bellevue, WA (US)

(73) Assignee: MICROSOFT CORPORATION, Redmond, WA (US)

(21) Appl. No.: 13/100,459

(22) Filed: May 4, 2011

(51) Int. Cl. G06F 17/30

(52) U.S. Cl. 707/822; 707/E17.01

(57) ABSTRACT

Methods, computer systems and computer readable media for optimizing non-deterministic computational paths are provided. In embodiments, requests are received to generate reports derived from a plurality of series of data files whose metadata attributes form certain mathematical structures that can be used to choose the optimal path in the non-deterministic dependency model. Storage for each of the series of data files is optimized. Available data files needed for the report are processed and missing data files are identified. Based on the mathematical structure of the plurality of series of data files, an optimal transition with the missing data files available is determined. An entry into the transition is triggered and the missing data files are processed. The report is generated and the optimized storage is retained for future requests.

### BACKGROUND

Data processing systems are often driven by multiple optional inputs and outputs. In such environments, the required inputs may arrive in a non-deterministic order and the required outputs may change over time, such that they cannot be predicted. Computation rules are also non-deterministic. As a result, scheduling the data processing for such systems involves searching exponential combinations of execution paths. One approach is to manually pick deterministic paths using heuristics. Unfortunately, this approach is inefficient because unnecessary intermediate results waste processing time and storage space. Data collections involved are often on the order of millions of terabytes. Further exacerbating the inefficiency is that, in many instances, the required inputs are spread across multiple resources, often in disparate locations. Overall, computation may be delayed because all possible paths to advance the computation are not considered. An efficient optimization algorithm that programmatically schedules computation for a non-deterministic dependency model based on data availability and demand is needed.

### SUMMARY

Embodiments of the present invention relate to systems, methods, and computer-readable media for, among other things, optimizing non-deterministic computational paths. In this regard, embodiments of the present invention receive requests to generate reports derived from a plurality of series of data files stored in a mathematical structure. Storage for each of the series of data files is optimized. Available data files needed are processed and missing data files are identified. Based on the mathematical structure of the plurality of series of data files, a transition with the missing data files available is determined. An entry into the transition is triggered and the missing data files associated with the transition are processed. A report is then generated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 schematically shows a network environment suitable for performing embodiments of the present invention.

FIG. 3 schematically shows a non-deterministic dependency model suitable for performing embodiments of the present invention;

FIG. 4 is a flow diagram showing a method for optimizing a non-deterministic computational path, in accordance with an embodiment of the present invention; and

FIG. 5 is a flow diagram showing a method for optimizing a non-deterministic computational path, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The following definitions are used to describe aspects of optimizing a non-deterministic computational path. A data file represents a log file corresponding to a specific set of features or items associated with user data or a set of user identifiers. A series of data files represents a collection of data files corresponding to the same set of specific features or items associated with user data or a set of user identifiers corresponding to a common dimension such as a time range. A plurality of series of data files represents more than one series of data files forming a mathematical structure. A transition represents a computation rule for identifying a missing data file and/or a subsuming data file. An entry provides information corresponding to the particular feature and time range corresponding to each data file and is triggered to process missing data files.

Embodiments of the present invention relate to systems, methods, and computer storage media having computer-executable instructions embodied thereon for optimizing non-deterministic computational paths. In this regard, embodiments of the present invention programmatically schedules computation for non-deterministic dependency models based on data availability and demand. The system inputs, outputs, and internal dependency subsystems are encoded as nodes in connected mathematical structures. A stage-wise optimization algorithm is utilized to traverse the non-deterministic dependency structure from the bottom to top (i.e., output to input) to determine stage-by-stage deterministic computation steps.

Accordingly, in one aspect, the present invention is directed to computer storage media having computer-executable instructions embodied thereon, that when executed, cause a computing device to perform a method for optimizing a non-deterministic computational path. The method includes receiving a request to generate a report. Features and a date range are extracted from the request. Data files for each extracted feature are merged to form a series of data files that satisfy the requested date range. A plurality of series of data files is merged to form a semi-lattice structure. An available data file necessary for the report is identified and a subsuming data file that subsumes the available data file is identified. The available data file is removed from processing and a transition is issued into the subsuming data file. This process is repeated until the structure has been reduced (i.e., there are no available data files that are subsumed by subsuming data files). The remaining subsuming data files are processed and missing data files needed to complete the report are identified. The supremum of all missing data files is calculated and a solved series of data files with a partial order relation with the supremum of all missing data files is identified. A transition is issued into the solved series of data files and an entry is triggered into the transition. The missing data files associated with the transition is processed. The steps to identify and process the missing data files are repeated until all missing data files have been processed and the report is generated.

In another aspect, the present invention is directed to computer storage media having computer-executable instructions embodied thereon, that when executed, cause a computing device to perform a method for optimizing a non-deterministic computational path. The method includes receiving a request to generate a report derived from a plurality of series of data files stored in a mathematical structure. Storage for each of the series of data files is optimized. Available data files are processed and missing data files needed to complete the report are identified. A transition with the missing data files available is determined based on the mathematical structure. An entry into the transition is triggered. Missing data files associated with the transition are processed and the report is generated.

In yet another aspect, the present invention is directed to a method for searching for images. The method includes translating visual features from a plurality of images into visual words associated with a dictionary. The visual words are indexed with at least one reference to the plurality of images. A sketched image is received and utilized to search the plurality of images for similar images. Visual features from the sketched image are translated into sketched image visual words. The index is searched for at least one match with the sketched image visual words. One or more similar images from the plurality of images associated with the at least one match is displayed.

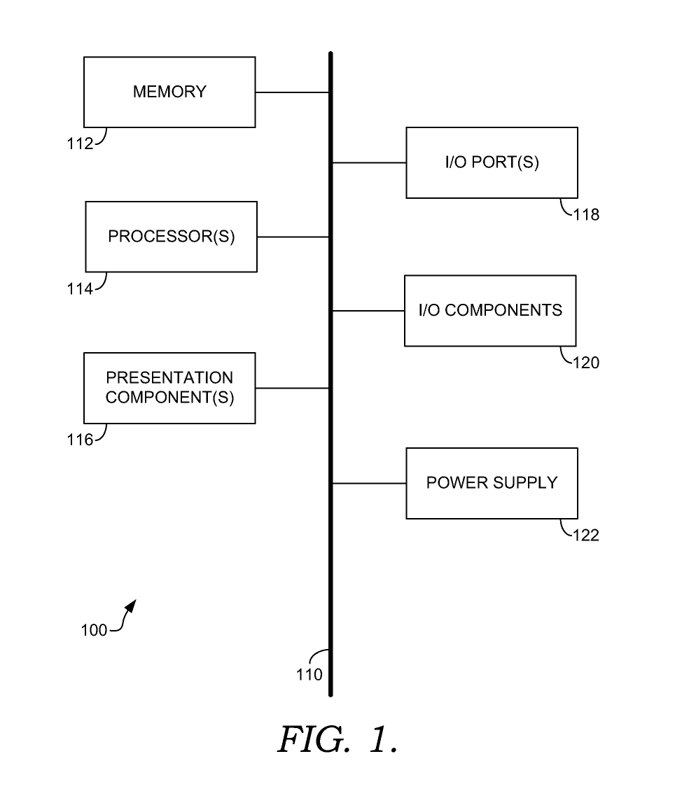

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

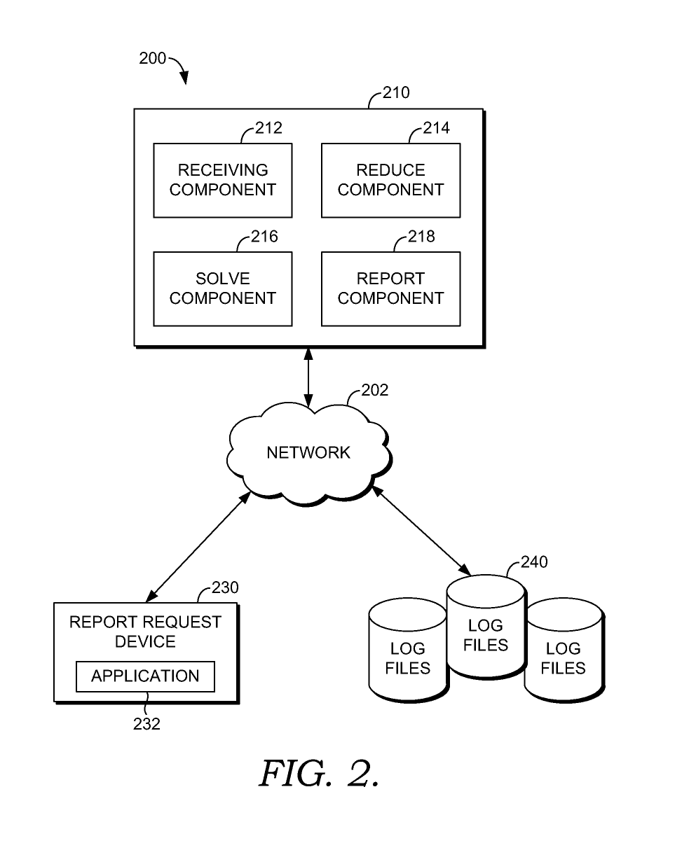

With reference to FIG. 2, a block diagram is illustrated that shows an exemplary computing environment 200 configured for use in implementing embodiments of the present invention. It will be understood and appreciated by those of ordinary skill in the art that the environment 200 shown in FIG. 2 is merely an example of one suitable environment and is not intended to suggest any limitation as to the scope of use or functionality of the present invention. Neither should the environment 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The environment 200 includes a network 202, an optimizing server 210, a report request device 230, and a plurality of log files 240. The network 202 includes any computer network such as, for example and not limitation, the Internet, an intranet, private and public local networks, and wireless data or telephone networks. The report request device 230 is any computing device, such as the computing device 100, from which a search query can be initiated. For example, the report request device 230 might be a personal computer, a laptop, a server computer, a wireless phone or device, a personal digital assistant (PDA), or a digital camera, among others. In an embodiment, a plurality of report request devices 230, such as thousands or millions of report request devices 230, is connected to the network 202.

The optimizing server 210 and the report request device 230 are communicatively coupled to a plurality of log files 240. The log files store 240 includes any available computer storage device, or a plurality thereof, such as a hard disk drive, flash memory, optical memory devices, and the like. The log files store 240 provides data storage for log files that may be provided as inputs to a report request in an embodiment of the invention. The log files store 240 may utilize any indexing data structure or format.

In one embodiment, the log files maintain information corresponding to user or device interaction with a search engine. These interactions may include user data and/or identification data. User data, as used herein, refers to any data in association with a user of a search engine and/or a device being used by the user to access the search engine. User data includes, for example, user profile data, device data, related data, global data, and/or the like. User data is any data or indicator in association with a user including, for example, habitual or routine behaviors of the user and/or indicators associated with events, activities, or behaviors of the user. User data may include, by way of example only, routine search behaviors of the user, searches or queries previously provided by the user, links to uniform resource locators (URLs) frequented by the user, and/or the like. As such, user data might be data that is identified or captured in association with user interaction of the search engine, the client, and/or the computing device of the user. User data may also include user information input and/or modified directly by the user (e.g., search terms). User data includes, in some embodiments, date and/or time stamps. In some embodiments, the date range and/or time stamps are stored in association with the user data. In some embodiments, user data includes information extracted from click analytics, behavioral targeting, geolocation, page tagging, logfile analysis, or a combination thereof. In some embodiments, user data can be captured or identified in association with a user identifier (e.g., a user identifier used by the user to log in) or a user device. The identification data may include, without limitation, internet protocol address, browser types, browser versions, cookies, and/or the like.

The optimizing server 210 includes any computing device, such as the computing device 100, and provides at least a portion of the functionalities for optimizing a non-deterministic computational path. In an embodiment a group of optimizing servers 210 share or distribute the functionalities for optimizing non-deterministic computational paths. As shown in FIG. 2, the optimizing server 210 includes a receiving component 212, a reduce component 214, a solve component 216, and a report component 218. In various embodiments, the optimizing server 210 includes an extraction component (not shown in FIG. 2), a data file merge component (not shown in FIG. 2), a series merge component (not shown in FIG. 2), and a retention component (not shown in FIG. 2).

Initially, when a requestor seeks to generate a report based on data stored by the log files store 240, the requestor accesses an application 232 on the report request device 230. The application 232 is capable of receiving or building a query against the log files store 240 for information relevant to the report. In an embodiment, the query is in Structured Query Language (SQL). The query may specify a condition or seek data for users according to a certain date range or time frame. As mentioned previously, the amount of data stored in the log files store 240 is typically on the order of several tens of terabytes of data every day. In practice, for example, a requestor may request an analysis of user behavior for every weekend from January 2011 to March 2011. The requestor initiates this request utilizing the application 232 from the report request device 230. The request is communicated via the network 202 to the optimizing server 210 where it is received by the receiving component 212.

The receiving component 212 receives, via the network, a request from the report request device 230. The request may include a date range, a time range, user data, identification data, or a combination thereof. Once the request is received by the receiving component 212, the extraction component extracts features and a date range from the request. In one embodiment, the data range is one of the features extracted by the extraction component. These features are often stored within the log files store 240 as one large data stream. Once the features are extracted by the extraction component, smaller streams are created by the extraction component for each extracted feature. Each stream is represented by a data file. In embodiments, these streams have already been created as remnants of previous requests.

A data file merge component (not shown in FIG. 2) merges the data files for each extracted feature to satisfy the requested date range to form a series of data files. A series merge component (not shown in FIG. 2) merges a plurality of series of data files to form a collection of mathematical structures. In one embodiment, the mathematical structures are semi-lattices. In various embodiments, the plurality of series of data files have already been created as remnants of prior merges.

Once the mathematical structures are created or already in existence from a previous request, the reduce 214 component optimizes storage for each of the series of data files. The reduce component 214 traverses the mathematical structure from the bottom (i.e., output) to the top (i.e., input) and identifies available data files that are subsumed by subsuming data files. The subsuming data files are other available data files that, in one embodiment, satisfy the algorithm:

For each existing available data file (a)

If there is another available data file (b) such that a sup b = b (i.e., a

has a partial order relation as derived from sup with b)

Remove data file a (as it is subsumed by b)

This algorithm is computed for all available data files until all redundant data files are removed from the series of data files.

Once the redundant data files have been removed candidate series of data files are traversed by the solve component 216 from the bottom (i.e., output) to the top (i.e., input) for processing. This optimizes processing and can be reused for additional or future requests. The algorithm identifies data files that are still needed (i.e., missing data files) for processing and groups those data files into a series of data files. Potential transitions are identified and an algorithm determines which transition should be triggered. In one embodiment, the algorithm issues a transition into a series of data files that includes at least some of the missing data files. In one embodiment, the algorithm issues a transition into a series of data files that includes all of the missing data files. This can be expressed, in one embodiment, if a particular series of data files has a partial order relation (derived from the sup operation) with the sup of all missing data files but does not have a partial order relation with the sup of all processed (i.e., available) data files. A transition is then issued into the particular series of data files and an entry into the transition is triggered. The missing data files are then processed. If the series of data files is not available, then they are grouped with the missing data files and the solve component repeats the process of identifying potential transitions until all missing data files are processed. Once all the missing data files are located and processed by the solve component, the report component 218 generates the report. A retention component (not shown in FIG. 2) retains the optimized storage that results from the above-described algorithms for future requests.

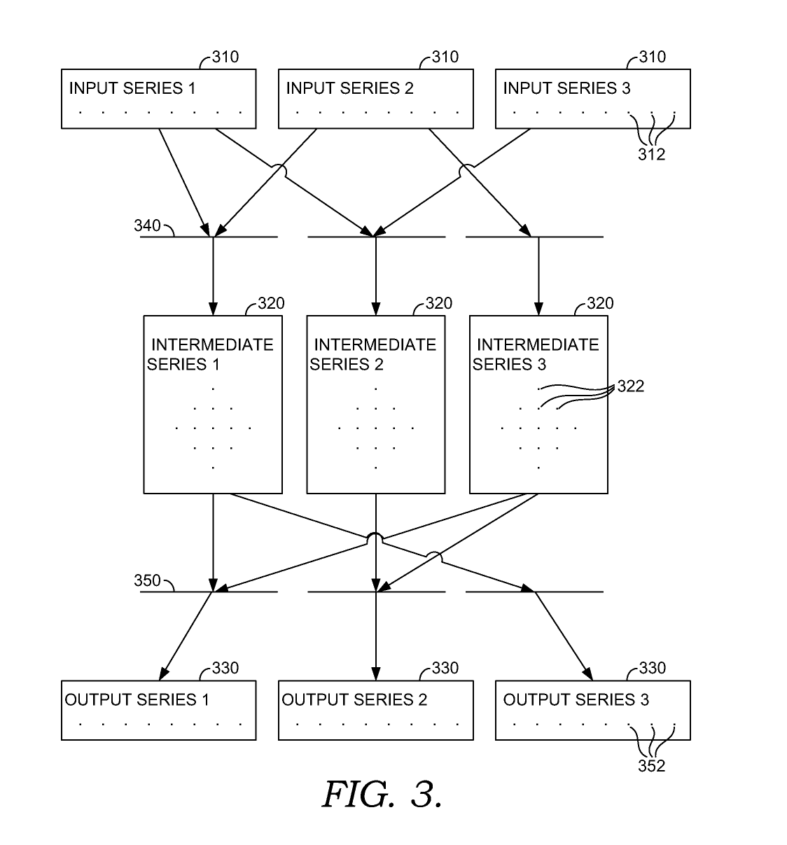

Referring now to FIG. 3, the input series 310 represent specific features that are maintained in log files. Each dot 312 represents a log file for a particular day or time range. For example, input series 1 may contain search logs for a specific search engine, input series 2 may contain search logs for a mobile search, and input series 3 may contain logs associated with tool bar usage. Each bar 340 represents a dependency between the features extracted by the extraction component. These dependencies may or may not exist depending on the report history. For instance, if the requestor creates new requirements or removes requirements, these dependencies may be created by the data file merge component for each feature extracted by the extraction component.

Because the required inputs (i.e., data) and the dependency rules are non-deterministic in nature, there are many possible paths to process the data and generate the report. For instance, in processing a given log, an error may have occurred resulting in a need to reinstate that particular log. Also, during the merge process discussed above, some logs are available before others. As can be appreciated, the structure depicted in FIG. 3 can be significantly larger with significantly more possible paths to the requested data.

The intermediate series 320 represents a first level of merged data files from the input series. Each dot 322 within the intermediate series 320 represents, in one embodiment, a merged data file corresponding to one or more extracted features for a given time period. The bar 350 represents a query submitted by a requestor and the output series 330 represents the output of the query. Each dot 352 within the output series corresponds to final data computed from any intermediate series 320 for a given time period. As can be appreciated, the number of queries 350 can be significantly greater than represented in FIG. 3, resulting in overlap of output series 330 and intermediate series 320.

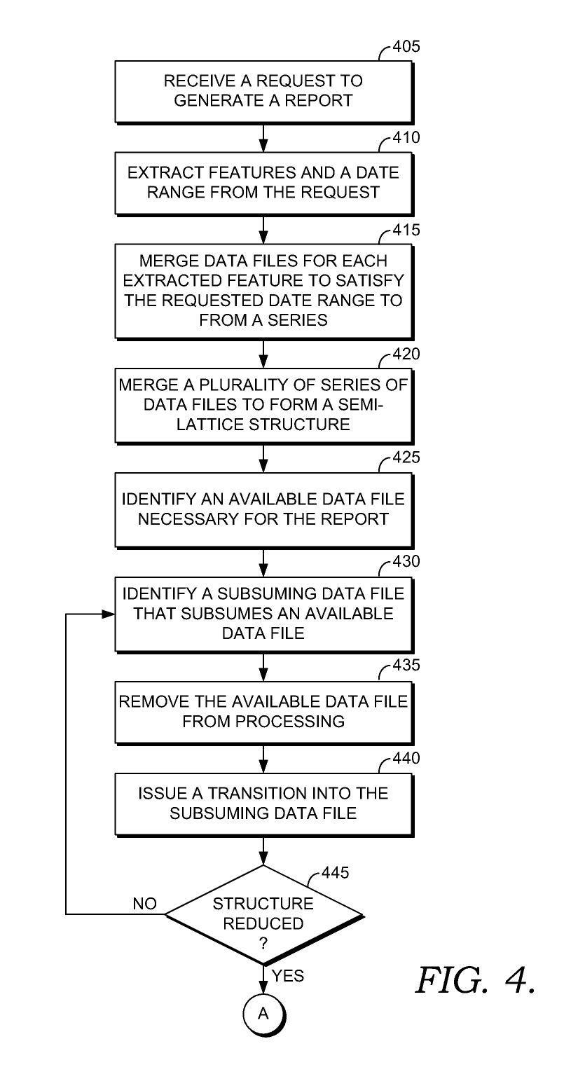

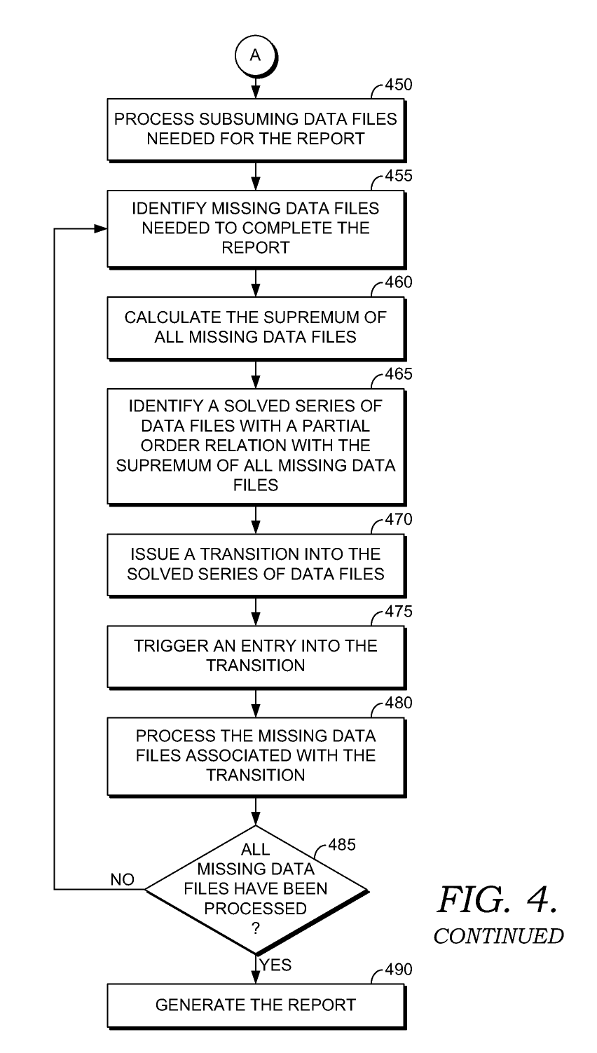

Referring now to FIG. 4, an illustrative flow diagram 400 is shown of a method for optimizing a non-deterministic computational path. A request for a report is received at step 405. Features and a date range, at step 410, are extracted from the request. Data files for each extracted feature are merged to satisfy the requested date range to form a series of data files at step 415. At step 420, a plurality of series of data files are merged to form a semi-lattice structure. Available data files necessary for the report are identified at step 425. In one embodiment, the semi-lattice structure is traversed from the bottom up (i.e., output to input). A subsuming data file that subsumes an available data file is identified at step 430. At step 435, the available data file is removed from processing. A transition is triggered into the subsuming data file at step 440 and the subsuming data file is now an available data file. At step 445, it is determined if the structure is reduced. More particularly, if a subsuming data file exists that subsumes an available data file, then steps 430 through 440 are repeated. If no subsuming data files exist that subsumes an available data file, then the structure is reduced. In one embodiment, the optimized storage is retained for future requests.

Once the structure is reduced, at step 450, the subsuming data files needed for the report are processed. Missing data files needed to complete the report are identified at step 455. The supremum of all missing data files are calculated at step 460. A solved series of data files with a partial order relation with the supremum of all missing data files is identified at step 465. A transition is issued, at step 470, into the solved series of data files. At step 475, an entry is triggered into the transition. The missing data files associated with the transition are processed at step 480. Steps 455 through 480 are repeated until all missing data files have been processed at step 485. The report is generated at step 490. In one embodiment, the report includes data associated with each of the extracted features for the requested data range.

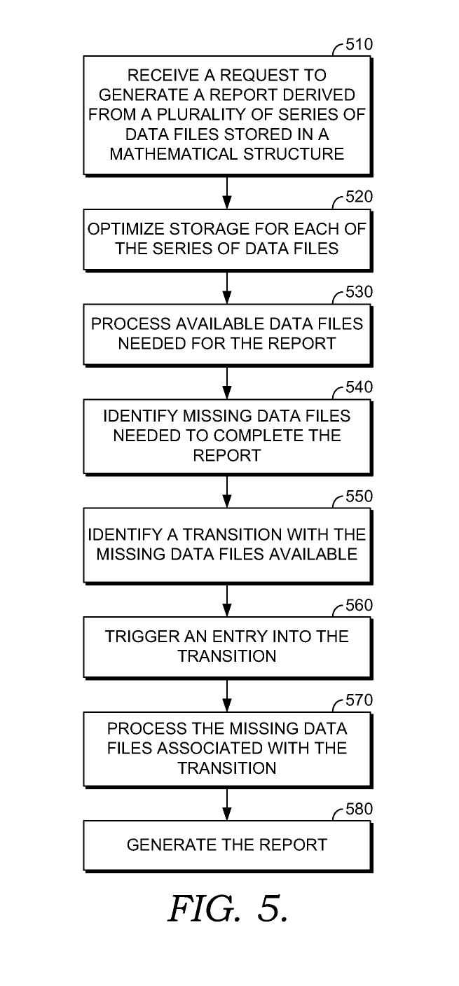

Referring now to FIG. 5, an illustrative flow diagram 500 is shown of a method for optimizing a non-deterministic computational path. At step 510, a request to generate a report derived from a plurality of series of data files stored in a mathematical structure is received. In one embodiment, features are extracted from the request. In one embodiment, the request includes a date range. Storage is optimized, at step 520, for each of the series of data files. In one embodiment, the mathematical structure is traversed from the bottom up (i.e., output to input). In one embodiment, the optimized storage is retained for future requests.

In one embodiment, data files for each extracted feature are merged to satisfy the requested date range to form a series of data files related to each extracted feature. In one embodiment, a plurality of data files of series of data files are merged to form the mathematical structure. In one embodiment, the mathematical structure is a semi-lattice.

In one embodiment, the storage is optimized by first determining each available data file. For each available data file, subsuming data files that subsume the available data file are identified. The available data file that is subsumed is removed from further processing and a transition is issued into the subsuming data file. The subsuming data file then becomes an available data file and the process is repeated until there are no longer any available data files subsumed by a subsuming data file.

Available data files needed for the report are processed at step 530. At step 540, missing data files needed to complete the report are identified. A transition with the missing data files available is identified at step 550. At step 560, an entry into the transition is triggered. The missing data files associated with the transition are processed at step 570. In one embodiment, determining a transition with the missing data files comprises calculating the supremum of all missing data files. A solved series of data files with a partial order relation with the supremum of all missing data files is identified. A transition into the solved series of data files is then issued. At step 580, the report is generated.

It will be understood by those of ordinary skill in the art that the order of steps shown in the method 400 and 500 of FIGS. 4 and 5 respectively are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for optimizing a non-deterministic computational path, the method comprising:
(a) receiving a request to generate a report;
(b) extracting features and a date range from the request;
(c) merging data files for each extracted feature to satisfy the requested date range to form a series of data files;
(d) merging a plurality of series of data files to form a semi-lattice structure;
(e) identifying an available data file necessary for the report;
(f) identifying a subsuming data file that subsumes the available data file;
(g) removing the available data file from processing;
(h) issuing a transition into the subsuming data file;
(i) repeating steps (d)-(h) until the structure has been reduced;
(j) processing subsuming data files needed for the report;
(k) identifying missing data files needed to complete the report;
(l) calculating the supremum of all missing data files;
(m) identifying a solved series of data files with a partial order relation with the supremum of all missing data files;
(n) issuing a transition into the solved series of data files;
(o) triggering an entry into the transition;
(p) processing the missing data files associated with the transition;
(q) repeating steps (k)-(p) until all missing data files have been processed; and
(r) generating the report.

2. The media of claim 1, further comprising traversing the semi-lattice structure from the bottom up.

3. The media of claim 1, further comprising retaining the optimized storage for future requests.

4. The media of claim 1, wherein the report includes data associated with each of the extracted features for the requested date range.

5. Computer-storage media storing computer-usable instructions, that, when executed by a computing device, perform a method for optimizing a non-deterministic computational path, the method comprising:
receiving a request to generate a report derived from a plurality of series of data files stored in a mathematical structure;
optimizing storage for each of the series of data files;
processing available data files needed for the report;
identifying missing data files needed to complete the report;
based on the mathematical structure, determining a transition with the missing data files available;
triggering an entry into the transition;
processing the missing data files associated with the transition; and
generating the report.

6. The media of claim 5, further comprising traversing the mathematical structure from the bottom up.

7. The media of claim 5, further comprising retaining the optimized storage for future requests.

8. The media of claim 5, further comprising extracting features from the request.

9. The media of claim 5, wherein the request includes a date range.

10. The media of claim 9, further comprising merging data files for each extracted feature to satisfy the requested date range to form a series of data files.

11. The media of claim 10, further comprising merging a plurality of series of data files to form the mathematical structure.

12. The media of claim 6, wherein the mathematical structure is a semi-lattice.

13. The media of claim 5, wherein optimizing storage comprises:
identifying each available data file;
identifying a subsuming data file that subsumes the available data file;
removing the available data file from processing; and
issuing a transition into the subsuming data file.

14. The media of claim 5, wherein determining a transition with the missing data files available comprises:
calculating the supremum of all missing data files;
identifying a solved series of data files with a partial order relation with the supremum of all missing data files; and
issuing a transition into the solved series of data files.

15. The media of claim 9, wherein the report includes each of the extracted features for the requested date range.

16. A computer system for optimizing a non-deterministic computational path, the computer system comprising a processor coupled to a computer-storage medium, the computer-storage medium having stored thereon a plurality of computer software components executable by the processor, the computer software components comprising:
a receiving component for receiving a request to generate a report derived from a plurality of series of data files stored in a mathematical structure;
a reduce component for optimizing storage for each of the series of data files;
a solve component for locating and processing missing data files needed to complete the report; and
a report component for generating the report after the solve component has located and processed all missing data files.

17. The computer system of claim 16, further comprising an extraction component for extracting features from the request.

18. The computer system of claim 16, further comprising a data file merge component for merging data files for each extracted feature to satisfy the requested date range to form a series of data files.

19. The computer system of claim 16, further comprising a series merge component for merging a plurality of series of data files to form a semi-lattice structure.

20. The computer system of claim 16, further comprising a retention component for retaining the optimized storage for future requests.
